(19) United States
(12) Patent Application Publication
(10) Pub. No.: US 2017/0083853 A1
(43) Pub. Date: Mar. 23, 2017

(54) DISPLAY DEVICE AND METHOD, MANAGEMENT APPARATUS, MANAGEMENT SYSTEM, AND NON-TRANSITORY COMPUTER READABLE MEDIUM

(71) Applicant: FUJI XEROX CO., LTD., Tokyo (JP)

(72) Inventor: Hayato YOSHIKAWA, Kanagawa (JP)

(73) Assignee: FUJI XEROX CO., LTD., Tokyo (JP)

(21) Appl. No.: 15/019,364

(22) Filed: Feb. 9, 2016

(30) Foreign Application Priority Data
Sep. 18, 2015 (JP) 2015-184957

(51) Int. Cl. G06Q 10/08

(52) U.S. Cl. CPC G06Q 10/087; G06Q 50/28

(57) ABSTRACT

A display device displays management information on a product shipped from a consignor to a consignee. Display details of particular management information displayed in a cooperative manner are different between the consignor and the consignee.

### CROSS-REFERENCE TO RELATED APPLICATIONS

This application is based on and claims priority under 35 USC 119 from Japanese Patent Application No. 2015-184957 filed Sep. 18, 2015.

### BACKGROUND

(i) Technical Field

The present invention relates to a display device and method, a management apparatus, a management system, and a non-transitory computer readable medium.

(ii) Related Art

There are cases in which a product such as a printer is distributed in such an order from a consignor (such as a manufacturer) to a final customer via a consignee (such as a first dealer) and another consignee (such as a second dealer). In such a case, when the product is managed separately at the consignor and the consignees, management information is redundantly input, for example.

### SUMMARY

According to an aspect of the present invention, there is provided a display device that displays management information on a product shipped from a consignor to a consignee. Displayed details of particular management information displayed in a cooperative manner are different between the consignor and the consignee.

### BRIEF DESCRIPTION OF THE DRAWINGS

An exemplary embodiment of the present invention will be described in detail based on the following figures, wherein:

FIG. 1 is a diagram illustrating a system configuration of a management system according to an exemplary embodiment of the present invention;

FIG. 2 is a block diagram illustrating a system configuration at a consignor according to the exemplary embodiment of the present invention;

FIG. 3 is a block diagram illustrating a hardware configuration of a terminal apparatus according to the exemplary embodiment of the present invention;

FIG. 4 is a schematic diagram illustrating the flow of a product and information in the exemplary embodiment of the present invention;

FIG. 5 is a plan view illustrating an example of details displayed on the terminal apparatus according to the exemplary embodiment of the present invention;

FIG. 6 is a flowchart illustrating a reception process performed by the terminal apparatus according to the exemplary embodiment of the present invention;

FIG. 7 is a flowchart illustrating a management information generating process performed by a server apparatus according to the exemplary embodiment of the present invention;

FIG. 8 is a screen diagram illustrating a screen, displaying management information, of a display device at the consignor according to the exemplary embodiment of the present invention;

FIG. 9 is a screen diagram illustrating a screen, displaying management information, of a display device at a first consignee according to the exemplary embodiment of the present invention; and

FIG. 10 is a screen diagram illustrating a screen, displaying management information, of a display device at a second consignee according to the exemplary embodiment of the present invention.

### DETAILED DESCRIPTION

Hereinafter, an exemplary embodiment of the present invention will be described in detail with reference to the drawings.

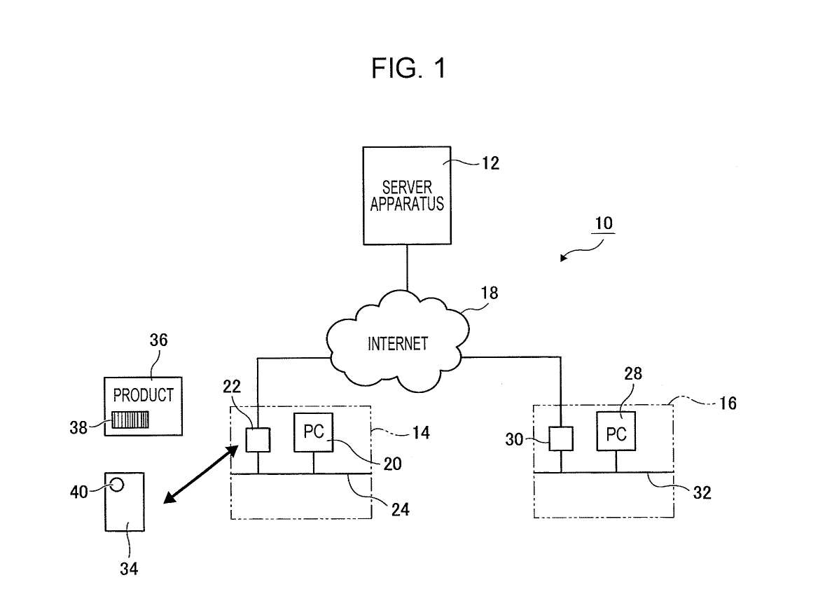

FIG. 1 illustrates a management system 10 according to an exemplary embodiment of the present invention.

The management system 10 includes a server apparatus 12 at a consignor (such as a manufacturer). The server apparatus 12 at the consignor is connected to a local network 14 at a first consignee (such as a first dealer A) and a local network 16 at a second consignee (such as a second dealer B) via the Internet 18, for example.

Note that the term “consignor” refers to a natural person or a legal person who ships a product to a natural person or a legal person; and the terms “first consignee” and “second consignee” each refer to a natural person or a legal person who receives a product from a natural person or a legal person, and further ships that product to another natural person or another legal person.

The local network 14 at the first dealer A includes, for example, a personal computer 20 and an access point 22 that are connected to each other via an internal network 24. Likewise, the local network 16 at the second dealer B includes, for example, a personal computer 28 and an access point 30 that are connected to each other via an internal network 32.

A terminal apparatus 34 is, for example, a smart phone. The terminal apparatus 34 is configured to read, with the use of a camera device 40 provided on the terminal apparatus 34, a code 38 such as a two-dimensional barcode attached to a package of a product 36 such as a printer, and to transmit the read data to the server apparatus 12.

Note that the terminal apparatus 34 is also prepared at the consignor and the second consignee.

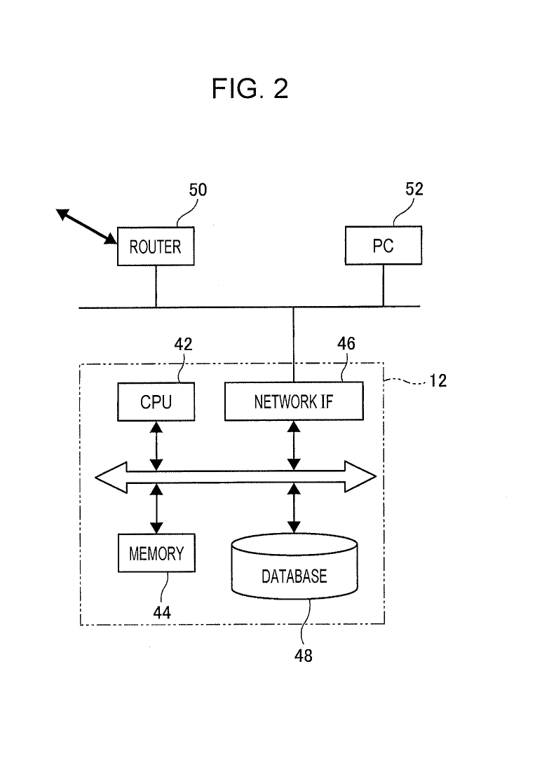

FIG. 2 illustrates a system configuration at the manufacturer side including the server apparatus 12.

In the server apparatus 12, a central processing unit (CPU) 42, a memory 44, a network interface 46, and a database 48 are connected to one another via a bus, for example. The CPU 42 controls the server apparatus 12 in accordance with a program stored in the memory 44. The server apparatus 12 is connected via the network interface 46 to a router 50 for connecting to the Internet 18, and to a personal computer 52. The database 48 stores management information regarding distribution of products. The management information includes, for example, each product's name, serial number, location, current status, customer, and failure information.

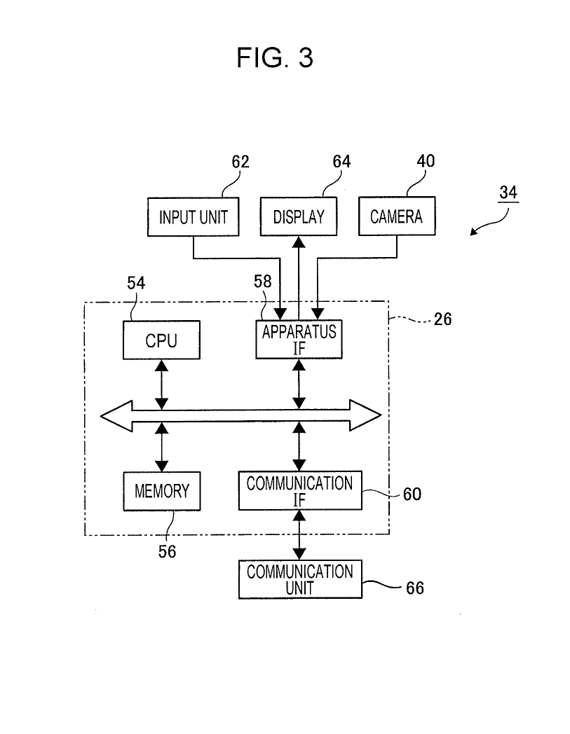

FIG. 3 illustrates a hardware configuration of the terminal apparatus 34.

The terminal apparatus 34 includes a controller 26. The controller 26 includes a CPU 54, a memory 56, an apparatus interface 58, and a communication interface 60 that are connected to one another via a bus or the like. The CPU 54 controls the terminal apparatus 34 in accordance with a program stored in the memory 56. An input unit 62 which is a touch screen or the like, a display 64 which is a liquid crystal display or the like, and the above-mentioned camera device 40 are connected to the apparatus interface 58. A communication unit 66 is connected to the communication interface 60. Data read by the camera device 40 is temporarily loaded into the memory 56, and then transmitted to the outside via the communication unit 66.

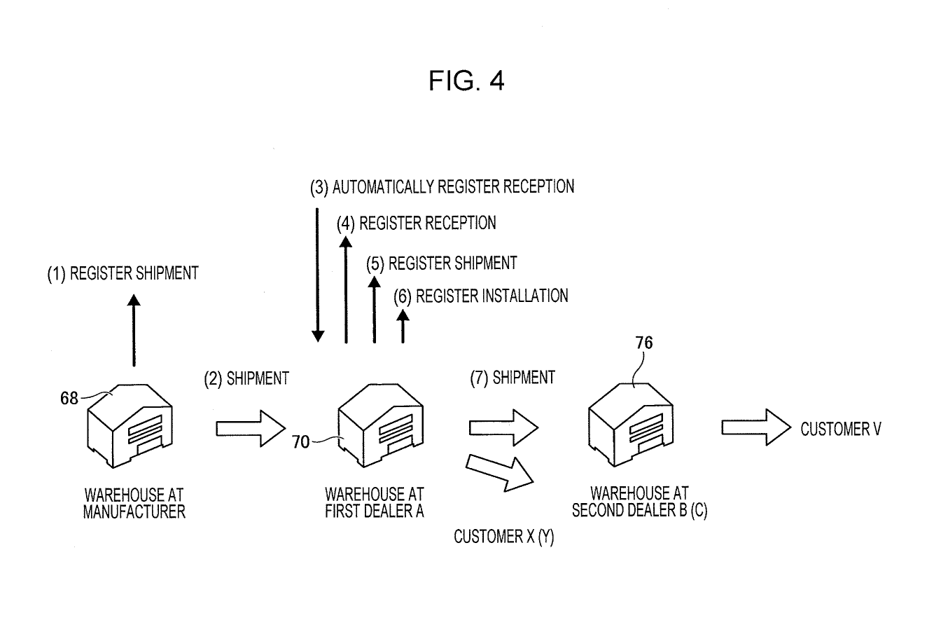

FIG. 4 illustrates the flow of a product and information.

The manufacturer assigns a serial number to each product at the time of manufacturing the product. Regarding the serial number, code information such as a two-dimensional barcode indicating the serial number is attached to a package of the product. In the case of shipping the product from a manufacturer warehouse 68, as illustrated in (1), information that the product is to be shipped is input by reading the barcode attached to the product using the above-mentioned terminal apparatus 34, the information is further output to the server apparatus 12 via the Internet 18, and the product is registered in the server apparatus 12 as being “shipped”. Meanwhile, the product is shipped from the manufacturer warehouse 68 to the first dealer A, as illustrated in (2).

Next, as illustrated in (3), in the case of the product whose serial number is registered at the manufacturer as being “shipped”, “incoming” is automatically registered at the first dealer A. That is, at the server apparatus 12, data registered as being “shipped” at the manufacturer side is automatically converted to “incoming” at the first dealer A side, and “incoming” is displayed at the first dealer A side, in which the displayed details are different in accordance with the respective positions of the manufacturer and the first dealer A.

The first dealer A performs registration indicating that the product has been received. Here, an inspection is performed on the actually received product by reading the barcode of the product using the terminal apparatus 34. The inspected product is received at a warehouse 70 at the first dealer A.

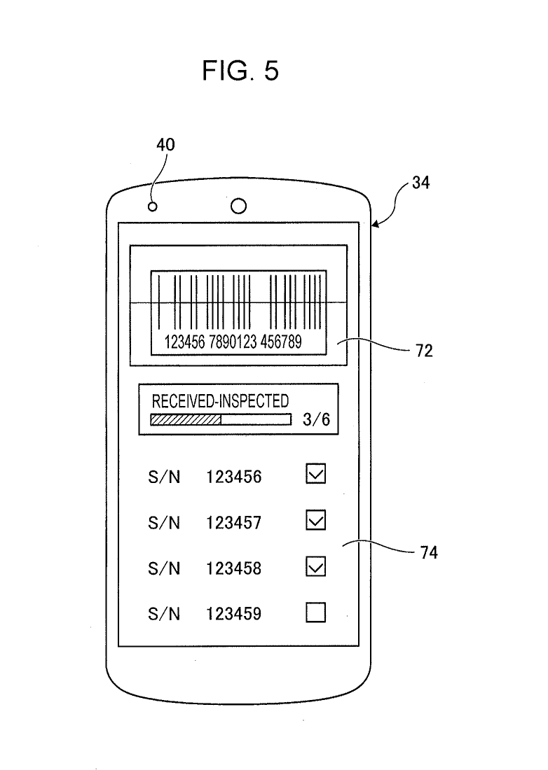

Specifically, as illustrated in FIG. 5, the terminal apparatus 34 includes a first display 72 that displays the barcode of a product, an image of which is captured by the camera device 40, and a second display 74 that displays information regarding an incoming product. The barcode displayed on the first display 72 is transmitted to the server apparatus 12. The second display 74 displays serial numbers and their corresponding checkboxes on a group by group basis. This screen indicates that one group includes six products, six serial numbers are displayed, and three products with the respective serial numbers have been inspected.

Note that the second display 74 displays up to four serial numbers due to a limited display area. The remaining two serial numbers are hidden in the second display 74 but will appear in the second display 74 by scrolling on the screen, for example.

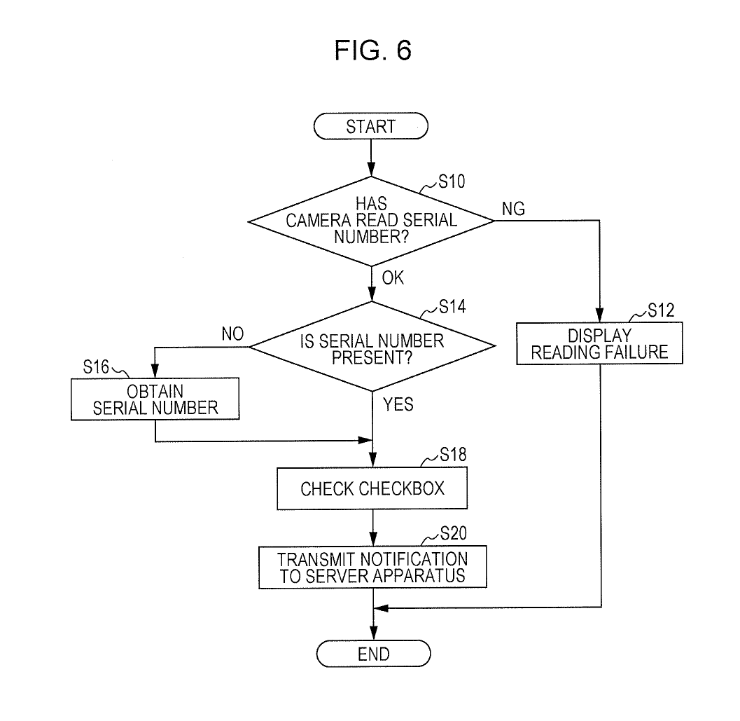

Now, the operation of the terminal apparatus 34 will be described. As illustrated in FIG. 6, first in step S10, it is determined whether the camera device 40 has successfully read the serial number of a product. If the serial number has not been read, the process proceeds to step S12, the terminal apparatus 34 displays that the serial number has not been read successfully, and the process is terminated. In contrast, if the serial number has been read successfully in step S10, the process proceeds to step S14. In step S14, it is determined whether the serial number is included in a group transmitted from the server apparatus 12. If it is determined that the serial number is not present (for example, in the case where a product with the above-read serial number has not been scheduled to be shipped from the manufacturer but actually has been shipped), the process proceeds to step S16, and the terminal apparatus 34 obtains the serial number from the server apparatus 12. If it is determined in step S14 that the serial number is present, or after step S16 is completed, the process proceeds to step S18, and a corresponding one of the checkboxes is checked. In step S20, the terminal apparatus 34 transmits, to the server apparatus 12, a notification indicating that the reception process has been completed, and the process is terminated.

Referring back to FIG. 4, at the first dealer A, the serial number of the received product is transmitted to the server apparatus 12, the product is registered as, for example, “warehouse”, and the actual product is received at the warehouse 70 at the first dealer A.

The first dealer A ships the product to the second dealer B (and further to the second dealer C) or to a customer X (and further to a customer Y), depending on the case. In the case where the product is shipped to the second dealer B, as illustrated in (5), information indicating shipment to the second dealer B is input by reading the barcode of the product using the terminal apparatus 34, the information is further output to the server apparatus 12 through the Internet 18, and the product is registered in the server apparatus 12 as being “shipped to B”. Meanwhile, the product is shipped from the warehouse 70 at the first dealer A to the second dealer B, as illustrated in (7).

In contrast, in the case where the product is shipped from the first dealer A to the customer X, as illustrated in (6), installation information is registered as an installation report after installation of the product. The installation information includes, besides the installed product's name, serial number, customer name, and installation date and year, information indicating whether there has been any installation failure.

Note that the flow of a product is not limited to that described above. For example, the second dealer B sometimes receives products of the same item not only from the first dealer A but also from another first dealer. In addition, in the case where the second dealer B refuses to disclose information to the first dealer A, the first dealer A is not allowed to access management information for the second dealer B.

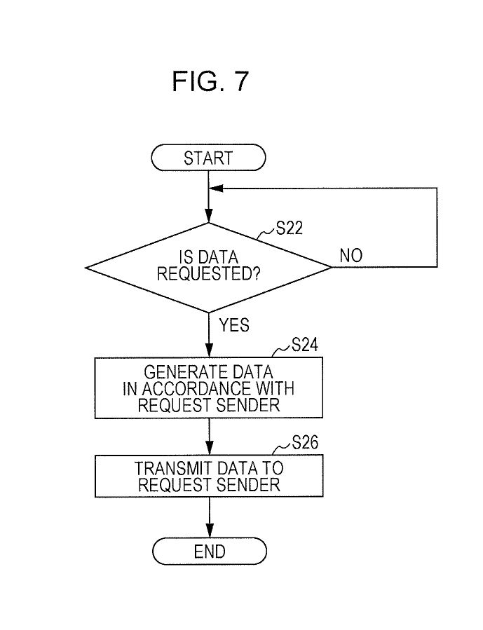

FIG. 7 illustrates the operation of the server apparatus 12 in the case where the manufacturer, the first dealer A, and the second dealer B give an access request to the server apparatus 12.

In step S22, the server apparatus 12 stands by until any of the manufacturer, the first dealer A, and the second dealer B requests data regarding management information. If it is determined in step S22 that there has been any data request, the process proceeds to step S24, and the server apparatus 12 obtains the management information from the database 48 and generates data in accordance with the request sender. That is, if a data request is sent from any one of the manufacturer, the first dealer A, and the second dealer B, the server apparatus 12 generates data in accordance with the position of the request sender. In step S26, the server apparatus 12 sends the data regarding the management information to the request sender, and ends the process.

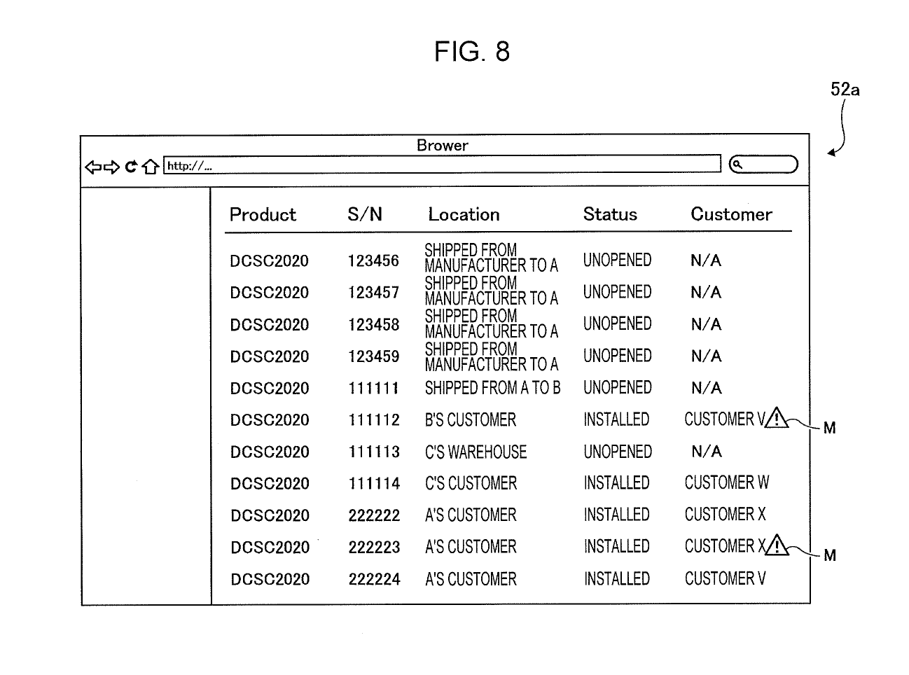

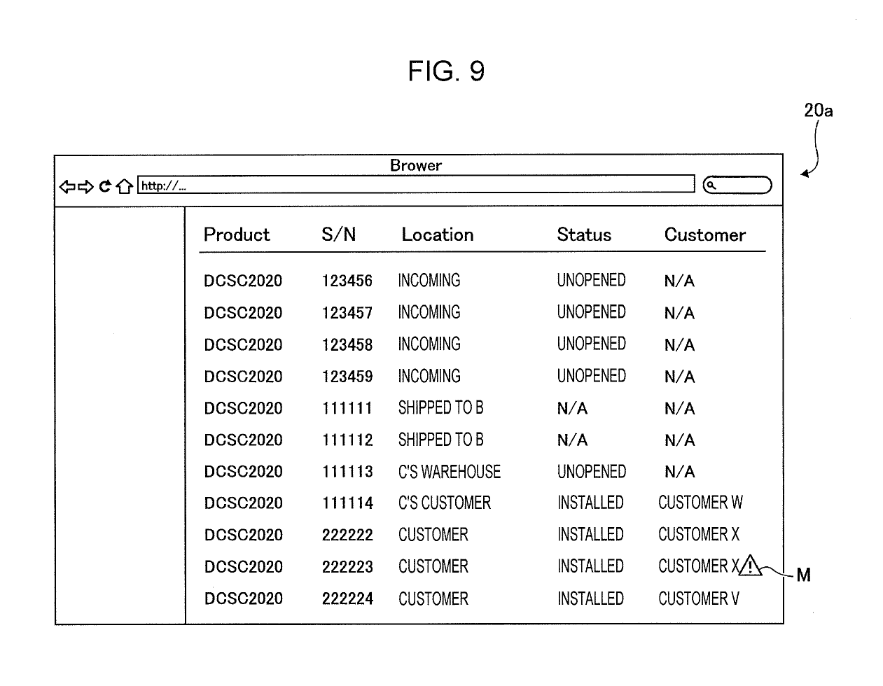

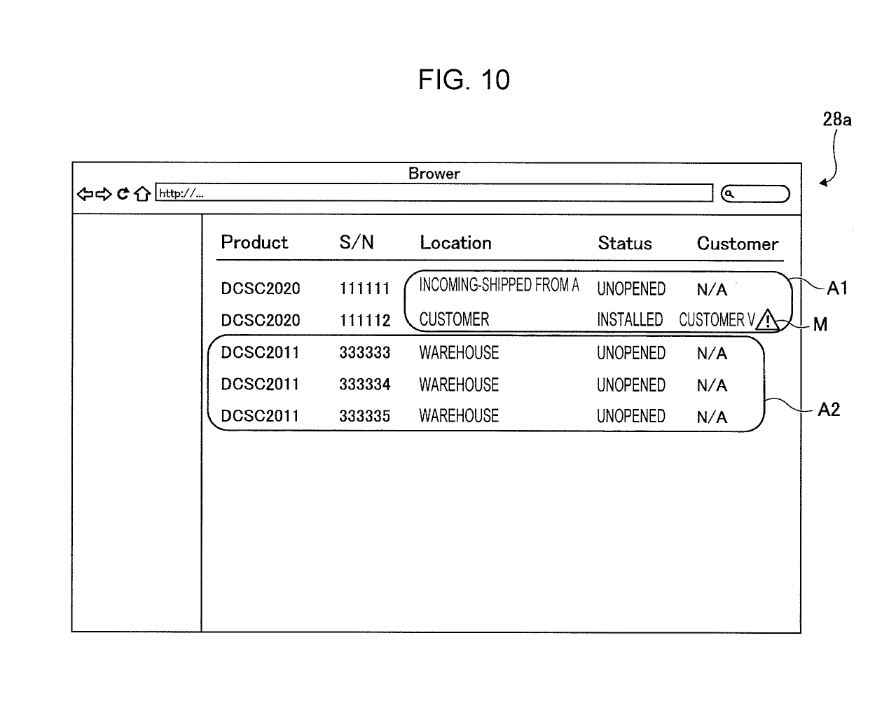

FIG. 8 illustrates, for example, a screen of a display device 52a of the PC 52 at the manufacturer. FIG. 9 illustrates a screen of a display device 20a of the PC 20 at the first dealer A. FIG. 10 illustrates a screen of a display device 28a of the PC 28 at the second dealer B.

As illustrated in FIG. 8, since products with the serial numbers 123456 to 123459 are being shipped from the manufacturer to the first dealer A, on the display device 52a at the manufacturer (manufacturer screen), the location “shipped from manufacturer to A”, the status “unopened”, and the customer “N/A” are displayed. Since a product with the serial number 111111 is being shipped from the first dealer A to the second dealer B, the location “shipped from A to B”, the status “unopened”, and the customer “N/A” are displayed. Since a product with the serial number 111112 has been installed at the customer V of the second dealer B, the location “B's customer”, the status “installed”, and the customer “customer V” are displayed. Since there has been an installation failure in the product with the serial number 111112, which has been installed at the customer V, a mark M indicating that there is an installation failure is displayed. Since a product with the serial number 111113 has been received by the second dealer C, the location “C's warehouse”, the status “unopened”, and the customer “N/A” are displayed. Since a product with the serial number 111114 has been installed at the customer W by the second dealer C, the location “C's customer”, the status “installed”, and the customer “customer W” are displayed. Since products with the serial numbers 222222 to 222224 have been installed at the customers X and Y by the first dealer A, the location “A's customer”, the status “installed”, and the customer “customer X” for the serial numbers 222222 and 222223 and the customer “customer Y” for the serial number 222224 are displayed. Since there has been an installation failure in the product with the serial number 222223, the mark M indicating that there is an installation failure is displayed.

Although not displayed on the screen, management information on products with the serial numbers 333333 to 333335 of a later-described DCSC2011 are displayed.

As illustrated in FIG. 9, since the products with the serial numbers 123456 to 123459 are “incoming”, not “shipped”, from the viewpoint of the first dealer A, on the display device 20a at the first dealer A (first dealer A screen), unlike the details displayed at the manufacturer, the location “incoming”, the status “unopened”, and the customer “N/A” are displayed. The second dealer B rejects disclosure of product management information to the first dealer A for reasons such as not wanting to disclose the customer information of the second dealer B. Therefore, for the products with the serial number 111111 and 111112, although the location “shipped to B” is displayed, the status “N/A” and the customer “N/A” are displayed. In contrast, C, which is also a second dealer, does not reject information disclosure. Thus, for the product with the serial number 111113, the location “C's warehouse”, the status “unopened”, and the customer “N/A” are displayed; and, for the product with the serial number 111114, the location “C's customer”, the status “installed”, and the customer “customer W” are displayed. Since the products with the serial numbers 222222 to 222224 have been installed at the customers X and Y by the first dealer A, the location “customer”, the status “installed”, and the customer “customer X” for the serial numbers 222222 and 222223 and the customer “customer Y” for the serial number 222224 are displayed. Since there has been an installation failure in the product with the serial number 222223, the mark M indicating that there is an installation failure is displayed, like the display screen at the manufacturer.

As illustrated in FIG. 10, since the products with the serial numbers 123456 to 123459, 111113, 111114, and 222222 to 222224 are not under management of the second dealer B, these products are not displayed on the display device 28a at the second dealer B (second dealer B screen). In addition, for the product with the serial number 111111, the location “incoming-shipped from A”, the status “unopened”, and the customer “N/A” are displayed. In addition, for the product with the serial number 111112, the location “customer”, the status “installed”, and the customer “customer V” are displayed. Since there has been an installation failure in the product with the serial number 111112, which has been installed at the customer V, the mark M indicating that there is an installation failure is displayed. A portion indicated by an area A1 includes management information not disclosed to the first dealer A. Since the serial numbers 333333 to 333335 indicated in an area A2 are management information on products received from dealers other than the first dealer A, the location “warehouse”, the status “unopened”, and the customer “N/A” are displayed.

Here, the manufacturer screen and the first dealer A screen are compared with each other. The location of each of the serial numbers 123456 to 123459 is “shipped from manufacturer to A” on the manufacturer screen, whereas the location thereof on the first dealer A screen is “incoming”. Accordingly, the displayed details are different. In addition, the location of the serial number 111111 is “shipped from A to B” on the manufacturer screen, whereas the location thereof on the first dealer A screen is “shipped to B”; and the status thereof on the manufacturer screen is “unopened”, whereas the status thereof on the first dealer A screen is “N/A”. Accordingly, the displayed details are different. In addition, the location of the serial number 111112 is “B's customer” on the manufacturer screen, whereas the location thereof on the first dealer A screen is “shipped to B”; the status thereof on the manufacturer screen is “installed”, whereas the status thereof on the first dealer A screen is “N/A”; and the customer thereof on the manufacturer screen is “customer V”, whereas the customer thereof on the first dealer A screen is “N/A”. Accordingly, the displayed details are different. In addition, the mark M indicating an installation failure is displayed on the manufacturer screen, whereas the mark M is not displayed on the first dealer A screen. The location of each of the serial numbers 222222 to 222224 is “A's customer” on the manufacturer screen, whereas the location thereof on the first dealer A screen is “customer”. Accordingly, the displayed details are different.

Now, the first dealer A screen and the second dealer B screen are compared with each other. The location of the serial number 111111 is “shipped to B” on the first dealer A screen, whereas the location thereof on the second dealer B screen is “incoming-shipped from A”. Accordingly, the displayed details are different. The location of the serial number 111112 is “B's customer” on the manufacturer screen, whereas the location thereof on the second dealer B screen is “customer”. Accordingly, the displayed details are different. Note that the mark M indicating an installation failure is displayed on both the manufacturer screen and the second dealer B screen. For the manufacturer, management information on all products shipped from the manufacturer is necessary.

Continuously, the manufacturer screen and the second dealer B screen are compared with each other. The location of the serial number 111111 is “shipped from A to B” on the manufacturer screen, whereas the location thereof on the second dealer B screen is “incoming-shipped from A”; and the status thereof on the first dealer A screen is “N/A”, whereas the status thereof on the second dealer B screen is “unopened”. Accordingly, the displayed details are different. In addition, the location of the serial number 111112 is “shipped to B” on the first dealer A screen, whereas the location thereof on the second dealer B screen is “customer”; the status thereof on the first dealer A screen is “N/A”, whereas the status thereof on the second dealer B screen is “installed”; and the customer thereof on the first dealer A screen is “N/A”, whereas the customer thereof on the second dealer B screen is “customer V”. Accordingly, the displayed details are different. In addition, the mark M indicating an installation failure is displayed on the second dealer B screen, whereas the mark M is not displayed on the first dealer A screen. For the first dealer A, the product with the serial number 111112 is a product not under management of the first dealer A.

Although the server apparatus 12 at the manufacturer manages the management information on products in the description of the exemplary embodiment, the exemplary embodiment of the invention is not limited thereto. Any management apparatus connected through a network such as the Internet may be used.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A display device that displays management information on a product shipped from a consignor to a consignee, displayed details of particular management information displayed in a cooperative manner being different between the consignor and the consignee.

2. The display device according to claim 1, wherein the particular management information is displayed using displayed details in accordance with respective positions of the consignor and the consignee.

3. A display device that displays management information on a product shipped from a consignor to a first consignee and further shipped from the first consignee to a second consignee, displayed details of particular management information displayed in a cooperative manner being different between at least one and another of the consignor, the first consignee, and the second consignee.

4. The display device according to claim 3, wherein the particular management information is displayed using displayed details in accordance with respective positions of the consignor, the first consignee, and the second consignee.

5. A management apparatus that manages management information on a product shipped from a consignor to a consignee, comprising:
a controller that performs control such that displayed details of particular management information displayed in a cooperative manner are different between the consignor and the consignee.

6. A management apparatus that manages management information on a product shipped from a consignor to a first consignee and further shipped from the first consignee to a second consignee, comprising:
a controller that performs control such that displayed details of particular management information displayed in a cooperative manner are different between at least one and another of the consignor, the first consignee, and the second consignee.

7. A management system comprising:
a management apparatus that manages management information on a product shipped from a consignor to a consignee;
a first display device that displays, at the consignor, management information managed by the management apparatus;
a second display device that displays, at the consignee, management information managed by the management apparatus; and
a controller that performs control such that displayed details of particular management information displayed in a cooperative manner are different between the first display device and the second display device.

8. A management system comprising:
a management apparatus that manages management information on a product shipped from a consignor to a first consignee and further shipped from the first consignee to a second consignee;
a first display device that displays, at the consignor, management information managed by the management apparatus;
a second display device that displays, at the first consignee, management information managed by the management apparatus;
a third display device that displays, at the second consignee, management information managed by the management apparatus; and
a controller that performs control such that displayed details of particular management information displayed in a cooperative manner are different between at least one and another of the first display device, the second display device, and the third display device.

9. A display method comprising:
managing management information on a product shipped from a consignor to a consignee; and
performing control such that displayed details of particular management information displayed in a cooperative manner are different between the consignor and the consignee.

10. A non-transitory computer readable medium storing a program causing a computer to execute a process, the process comprising:
managing management information on a product shipped from a consignor to a consignee; and
performing control such that displayed details of particular management information displayed in a cooperative manner are different between the consignor and the consignee.

11. A non-transitory computer readable medium storing a program causing a computer to execute a process, the process comprising:
managing management information on a product shipped from a consignor to a first consignee and further shipped from the first consignee to a second consignee; and
performing control such that displayed details of particular management information displayed in a cooperative manner are different between at least one and another of the consignor, the first consignee, and the second consignee.
